(19) United States
(12) Patent Application Publication
(10) Pub. No.: US 2026/0017460 A1
(43) Pub. Date: Jan. 15, 2026

(54) METHOD, APPARATUS, ELECTRONIC DEVICE, STORAGE MEDIUM AND PRODUCT OF MARKING API INTERFACE

(71) Applicant: Beijing Volcano Engine Technology Co., Ltd., Beijing (CN)

(72) Inventors: Yunpeng ZHANG, Beijing (CN); Yuanming HU, Beijing (CN); Ting CAI, Beijing (CN); Xiaodong SU, Beijing (CN); Heping JIANG, Beijing (CN)

(21) Appl. No.: 19/331,795

(22) Filed: Sep. 17, 2025

(30) Foreign Application Priority Data
Sep. 18, 2024 (CN) 202411303185.3

(51) Int. Cl. G06F 40/30

(52) U.S. Cl. CPC G06F 40/30

(57) ABSTRACT

The present disclosure provides a method, apparatus, electronic device, storage medium and product of marking an API interface. The method comprises: obtaining API interface information in API interface access traffic data; inputting the API interface information into a target model to obtain first information about the API interface information output by the target model; wherein the first information comprises at least one of: functional description information and interface name information of the API interface, and wherein the target model is trained based on first training data, and the first training data comprises first interface information and at least one of corresponding first functional description information or first interface name information; and marking the API interface based on the first information.

### CROSS-REFERENCE TO RELATED APPLICATION(S)

The present application claims priority to Chinese Patent Application No. 202411303185.3, filed on Sep. 18, 2024, and entitled “METHOD, APPARATUS, ELECTRONIC DEVICE, STORAGE MEDIUM AND PRODUCT OF MARKING API INTERFACE”, which is hereby incorporated by reference in its entirety.

### FIELD

The present disclosure relates to the field of computer technology, and in particular, to a method, apparatus, electronic device, storage medium and product of marking an API interface.

### BACKGROUND

An API (application program interface) is an interface for an application to provide services to the outside, allowing data and functionality to be shared between different applications, services or modules. However, recorded information of an existing API interface often makes it difficult to directly discern the role or functionality of the API interface, which compounds the maintenance and operation difficulty and increases the cost of operations and security protection.

### SUMMARY

In a first aspect, the present disclosure provides a method of marking an API interface, comprising:
obtaining API interface information in API interface access traffic data;
inputting the API interface information into a target model to obtain first information about the API interface information output by the target model; wherein the first information comprises at least one of: functional description information and interface name information of the API interface, and wherein the target model is trained based on first training data, and the first training data comprises first interface information and corresponding first functional description information and/or first interface name information; and
marking the API interface based on the first information.

In a second aspect, the present disclosure provides an apparatus of marking an API interface, comprising:
an obtaining module configured to obtain API interface information in API interface access traffic data;
a model module configured to input the API interface information into a target model to obtain first information about the API interface information output by the target model; wherein the first information comprises at least one of: functional description information and interface name information of the API interface, and wherein the target model is trained based on first training data, and the first training data comprises first interface information and corresponding first functional description information and/or first interface name information; and
a marking module configured to mark the API interface based on the first information.

In a third aspect, the present disclosure provides an electronic device, comprising a memory, a processor and a computer program stored on the memory and runnable on the processor, wherein the processor, when executing the program, implements a method according to the first aspect.

In a fourth aspect, the present disclosure provides a non-transitory computer readable storage medium, storing computer instructions which are used for causing the computer to perform a method according to the first aspect.

Based on the same inventive concept, in a fifth aspect, an example embodiment of the present disclosure provides a computer program product, comprising computer program instructions, wherein the computer program instructions, when running on a computer, cause the computer to perform a method according to the first aspect.

### BRIEF DESCRIPTION OF THE DRAWINGS

To illustrate the technical solution in the present disclosure or in the prior art more clearly, a brief introduction is presented below to the accompanying drawings to be used in the description of the embodiments or the prior art. It is obvious that the accompanying drawings in the following description are merely some of the embodiments of the present disclosure. Those of ordinary skill in the art may further derive other figures from these accompanying drawings without the exercise of any inventive skill.

FIG. 1 illustrates a schematic flowchart of a method of marking an API interface according to an embodiment of the present disclosure;

FIG. 2 illustrates a schematic diagram of a method of marking an API interface according to an embodiment of the present disclosure;

FIG. 3 illustrates a schematic diagram of an example apparatus according to an embodiment of the present disclosure; and

FIG. 4 illustrates a hardware structural schematic diagram of an example computing device according to an embodiment of the present disclosure.

### DETAILED DESCRIPTION OF EMBODIMENTS

To make the objectives, technical solutions and advantages of the present disclosure clearer and more explicit, the present disclosure will be described in further detail in conjunction with example embodiments and with reference to the accompanying drawings.

It is to be noted that unless otherwise defined, the technical terminology or scientific terminology used in the embodiments of the present disclosure shall have the ordinary meaning understood by those of ordinary skill in the art. The terms “first”, “second” and the like used herein do not represent any order, quantity or importance, but are for differentiating different components. The terms “comprise”, “include” and the like mean that an element or object preceding the term covers elements or objects enumerated after the word and their equivalents, without excluding other elements or objects. The term “connected to” or “connected with” and the like is not limited to physical or mechanical connections, but may include electrical connections, whether direct or indirect. The terms “up”, “down”, “left”, “right” and so on are only used to represent relative positional relationships, when the absolute position of the object being described changes, the relative positional relationship which might also change accordingly when the absolute position of a described object is changed.

It is to be understood that, before applying the technical solutions disclosed in various embodiments of the present disclosure, the user may be informed of the type, scope of use, and use scenario of the personal information involved in the present disclosure in an appropriate manner, and user authorization may be obtained.

For example, in response to receiving an active request from the user, prompt information is sent to the user to explicitly inform the user that the requested operation would acquire and use the user's personal information. Therefore, according to the prompt information, the user may decide on his/her own whether to provide the personal information to the software or hardware, such as electronic devices, applications, servers, or storage media that perform operations of the technical solutions of the present disclosure.

As an optional but non-limiting implementation, in response to receiving an active request from the user, the way of sending the prompt information to the user may, for example, include a pop-up window, and the prompt information may be presented in the form of text in the pop-up window. In addition, the pop-up window may also carry a select control for the user to choose to “agree” or “disagree” to provide the personal information to the electronic device.

It is to be understood that the above process of notifying and obtaining the user authorization is only illustrative and does not limit the implementations of the present disclosure. Other methods that satisfy relevant laws and regulations are also applicable to the implementations of the present disclosure.

It is to be understood that data involved in the present technical solution (including but not limited to the data itself, the acquisition or use of the data) may comply with requirements of corresponding laws and regulations and relevant rules.

To make the objectives, technical solutions and advantages of the present disclosure clearer and more explicit, the principles and spirit of the present disclosure will be described with reference to several example implementations. It is to be understood that these implementations are merely provided to enable those skilled in the art to better understand and implement the present disclosure, rather than limiting the scope of the present disclosure in any manner. On the contrary, these implementations are provided for the more thorough and complete understanding of the present disclosure and to convey the scope of the present disclosure to those skilled in the art completely.

It is to be understood that the number of any element in the accompanying drawings is used for illustrative purposes without limitation, and that any naming is used for differentiation only and does not have any limiting meaning.

The principles and spirit of the present disclosure are explained in detail below with reference to several representative implementations of the present disclosure.

An API (application program interface) is a set of functions that manipulate a component, application program, or operating system to allow different application programs to communicate with each other, share data, and integrate in an orderly fashion. The main purpose of an API is to allow application program developers to call a set of routines without having to consider the underlying source code or understand the details of its inner working mechanism. Due to the increasing variety and number as well as complexity of application programs, iterative updating of application programs is very frequent, resulting in frequent iterations of API interfaces. In order to manage an API interface, maintenance information of the API interface may be automatically discovered or manually maintained. However, current maintenance information of the API interface usually only records the path, request method and parameters of the API interface, and the user has no way of knowing the role or function of the API interface. In practice, there are usually hundreds of API interfaces in use for a domain name, which makes the maintenance and operation of API interfaces very difficult, increases the operation cost and security protection cost and lowers the maintenance efficiency and operation efficiency. Therefore, how to reduce the difficulty of maintenance and operation of the API interface, reduce the operation cost and the security protection cost and improve the maintenance efficiency and operation efficiency has become a technical problem that needs to be solved urgently.

In view of this, it is an objective of the present disclosure to propose a method, apparatus, electronic device, storage medium and product of marking an API interface, so as to solve, at least to a certain extent, the technical problems in the prior art such as increased difficulty in maintaining and operating API interfaces, as well as increased operating costs and security protection costs.

The example embodiments of the present disclosure provide a solution of marking an API interface. The solution of marking an API interface can semantically understand the interface information of the API interface to determine the functional description information and interface name information of the API interface, so as to mark the API interface, which is convenient for users to use and manage and is applicable to various network security scenarios.

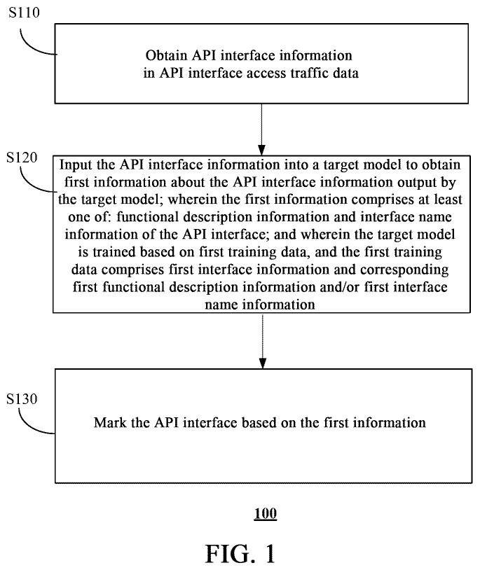

With reference to FIG. 1, the figure shows a schematic flowchart of a method of marking an API interface. The method of marking an API interface according to an embodiment of the present disclosure may be deployed on the terminal or server side. In FIG. 1, marking 100 an API interface may further comprise the following.

At step S110, API interface information in API interface access traffic data is obtained.

The API interface access traffic data may refer to recorded data related to access to the API interface, comprising the number of requests, frequency, source, response time and other data. For example, the number of requests may refer to a count that a certain API interface is called in a day; the response time may refer to the average time for the API interface to process a request and return a response. Obtaining the access traffic data may usually collect access traffic data in a target system or a target system cluster, and capture the use situation of the API interface through logging, traffic detection tools, or other methods. Logging comprises an API gateway or server recording detailed information about each request, such as request time, response time, request method (GET, POST, etc.), client IP address, etc. The access traffic data may be either log stream data fused from multiple sources or access logs backed up in a database, which is not limited here.

The API interface information may refer to various description and metadata related to the API interface, such as: interface path (Endpoint), used to define a target location of the API interface request; invocation approach (HTTP approach), used to specify how to interact with the API interface, where common approaches comprise GET, POST, PUT, DELETE, etc. Request parameters may refer to the input data that the API interface expects to receive, which may be query string parameters, path parameters, or data in the request body. The API interface information may further comprise response format, status code, version control, authentication and authorization, rate limiting, documentation and examples, error handling and other information.

At step S120, the API interface information is input into a target model to obtain first information about the API interface information output by the target model, where the first information comprises at least one of: functional description information and interface name information of the API interface, and where the target model is trained based on first training data, and the first training data comprises first interface information and corresponding first functional description information and/or first interface name information.

The target model may refer to a model for performing information extraction and semantic analysis based on the API interface information to determine functional description and/or name information of a corresponding API interface. The first information may refer to key information capable of identifying or describing the API interface, the functional description information may refer to a description of the functionality of the API interface, and the interface name information may refer to named identification of the API interface, such as a descriptive name or path.

For example, a large amount of marked API interface information and corresponding interface functional description information and/or interface naming description information may be collected as the first training data to train an initial model, thereby obtaining a target model capable of outputting corresponding API functional description information and/or name information based on the input API interface information. In the training process of the target model, a corresponding output result may be generated based on the first interface information (which may be obtained, for example, based on configuration information of the API interface) in the first training data, i.e., functional description information and/or interface name information may be output. The output result is compared with the actual first functional description information and/or first interface name information, and parameters of the target model may be adjusted based on minimizing the cross-entropy loss between the output result and the actual first functional description information and/or the first interface name information, thereby obtaining a trained target model.

In some embodiments, inputting the API interface information into the target model to obtain the first information about the API interface information output by the target model comprises:
performing, by the target model, semantic analysis on an interface path and an invocation approach in the API interface information to obtain a first analysis result; and
determining the first information based on the first analysis result.

The interface path may refer to a path portion in URL (Uniform Resource Locator) of the API interface, which specifies a requested target resource or resource set. The interface path usually follows a protocol (e.g., HTTP/HTTPS) and a domain name, for identifying a specific resource or service. The invocation approach may refer to an approach of an HTTP request, which indicates the type of operation which the client desires to perform. Common HTTP approaches comprise GET, POST, PUT, DELETE, PATCH, etc. For example, GET may be used for requesting to obtain information of a resource; POST may be used for submitting data to the server, usually for creating a new resource; PUT may be used for updating a resource, usually replacing a whole resource; DELETE may be used for deleting a resource; PATCH may be used for partially updating a resource. The semantic analysis may refer to determining the functionality and usage of the API interface by understanding and interpreting content involved in the API interface information, e.g., the meaning of the interface path and invocation approach. For example, given that the API interface information comprises the interface path: /products and the invocation approach: GET, semantic analysis may be performed by the target model, and the input first analysis result is an interface for obtaining product information. At this point, the functional description information in the first information may be to “obtain a product list”. In this way, the functionality of the API interface may be automatically identified, thereby helping the user to manage and utilize the API interface more efficiently and further helping to reduce work costs and enhance work efficiency.

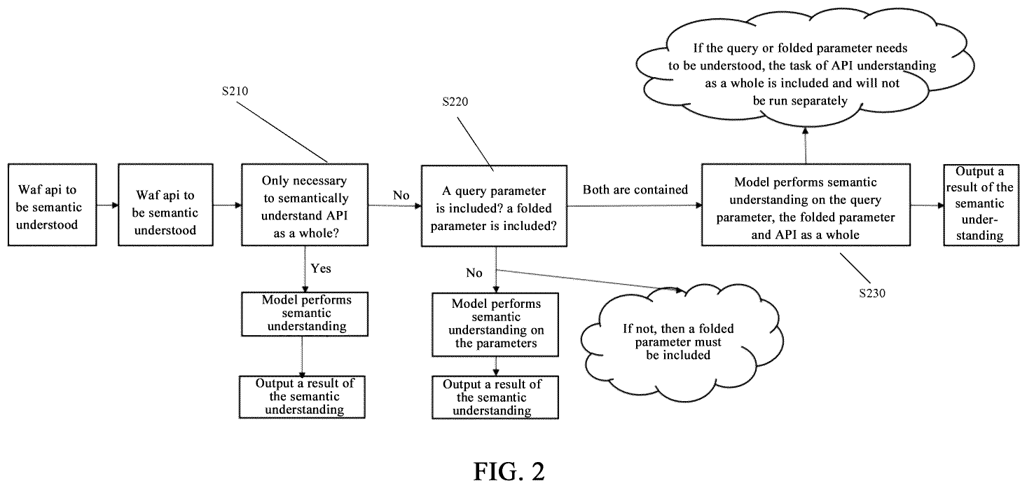

For example, the API interface information may include the interface path and the invocation approach, the API interface information may be semantically analyzed as a whole based on the target model to obtain the first analysis result. With reference to FIG. 2, the figure shows a schematic diagram of a marking of marking an API interface according to an embodiment of the present disclosure. In FIG. 2, after obtaining the API interface information, it may be judged whether the API interface information comprises an interface path and an invocation approach; if yes, then semantic analysis may be performed based on the interface path and the invocation approach; if not, then the flow may end, or API interface information may be obtained again. Further, it may be judged whether the API interface information comprises only an interface path and an invocation approach, as shown by S210 in FIG. 2. If the API interface information only comprises the interface path and the invocation approach, it means that means that only the overall semantic analysis of the API interface information is needed, without the need of the partial analysis of other parameters. If the API interface information comprises more than the interface path and the invocation approach, it means that semantic analysis needs to be performed on other key parameters to determine the functionality of the API interface more accurately.

In some embodiments, inputting the API interface information into the target model to obtain the first information about the API interface information output by the target model comprises:
aggregating and folding the API interface information to obtain a folded parameter of the API interface information;
in response to determining that the API interface information comprises the folded parameter, performing, by the target model, semantic analysis on the interface path, the invocation approach and the folded parameter to obtain a second analysis result; and
determining the first information based on the first analysis result or the second analysis result.

After obtaining the access traffic data, the access traffic data may be aggregated and folded to obtain the meaning and functionality of the folded parameter in the access traffic data. At this point, semantic analysis may be performed on the interface path, the invocation approach and the folded parameter to obtain a second analysis result. Then, the final first information may be determined from the first analysis result or the second analysis result.

A field parameter in the access traffic data and a corresponding field value is obtained by aggregating and folding the API interface information, then the field parameter is folded and identified based on the field value corresponding to the field parameter to obtain an interface access path and an interface access parameter stored in the field parameter, and further interface folded information is obtained based on the interface access path and the interface access parameter. The access traffic data comprises a plurality of field parameters, and a respective field parameter may be folded and identified based on a field value corresponding to the field parameter, i.e., the role of a field parameter may be inferred based on the content of a field value corresponding to the field parameter. For example, the field parameter is used for storing which information, and field parameters having the same role are folded, thereby obtaining the interface access path, the interface access parameter and other interface folded information stored in the field parameter. Further, a domain name may be obtained. That is, basic API interface information may be obtained based on a combination of the domain name, the interface access path and the interface access parameter.

In some embodiments, the first analysis result has a first confidence, the second analysis result has a second confidence, and the first confidence is less than a confidence threshold;
and where determining the first information based on the first analysis result or the second analysis result comprises:
in response to determining that the second confidence is greater than or equal to the confidence threshold, determining the second analysis result as the first information;
in response to determining that the second confidence is less than the confidence threshold and the second confidence is greater than or equal to the first confidence, determining the second analysis result as the first information; or
in response to determining that the first confidence is greater than the second confidence, determining the first analysis result as the first information.

If the first confidence of the first analysis result is greater than or equal to the confidence threshold, then the first analysis result may be directly determined as the first information, without the need of performing further analysis and other subsequent tasks on the folded parameter or the query parameter. If the first confidence of the first analysis result is less than the confidence threshold, then the folded parameter or the query parameter needs to be further analyzed to enhance the accuracy of semantic analysis of the API interface information. In FIG. 2, if the API interface information comprises not only the interface path and the invocation approach but also the folded parameter, then semantic analysis may be performed in conjunction with the folded parameter, the interface path and the invocation approach, as shown by S220 in FIG. 2. Thereby, the role and functionality of the API interface is determined, and a second analysis result with more accurate interface functional description information is obtained. At this point, if the second confidence of the second analysis result is greater than or equal to the confidence threshold, then the second analysis result may be directly determined as the first information, without the need to subsequently performing semantic analysis of the query parameter. If the second confidence of the second analysis result is less than the confidence threshold, then both the confidences of the first analysis result and the second analysis result are less than the confidence threshold, and further the analysis result with a greater confidence may be determined as the first information. For example, when the first analysis result is greater than the second analysis result, the first analysis result is determined as the first information; when the first analysis result is less than the second analysis result, the second analysis result is determined as the first information.

The method of marking an API interface as described in the present embodiment, after obtaining the interface path, the invocation approach, the folded parameter and other API interface information in the access traffic data, semantically understands the API interface information to thereby obtain the functional description information and the interface name information. The interface name information may be summarized based on the interface functional description information and described as a readable role and name, so that the interface name information of the API interface is obtained. In this way, the functionality of the API interface may be presented more intuitively, the work convenience may be further improved, and easier use and management may be facilitated for users.

In some embodiments, inputting the API interface information into the target model to obtain the first information about the API interface information output by the target model comprises:
in response to determining that the API interface information further comprises a query parameter, performing, by the target model, semantic analysis on the interface path, the invocation approach, the folded parameter and the query parameter to obtain a third analysis result; and
determining the first information based on the first analysis result, the second analysis result or the third analysis result.

The query parameter may refer to a query string portion in URL, e.g., a query string following a question mark (?) in URL and formed by a series of key-value pairs, where key-value pairs are connected by an equal sign (=), and a plurality of key-value pairs are separated by an and sign (&). When the API interface information further comprises a query parameter, semantic analysis may further be performed in conjunction with the interface path, the invocation approach, the folded parameter and the query parameter, thereby obtaining a third analysis result to further enhance the accuracy of semantic analysis. Then, the final first information may be determined from the first analysis result, the second analysis result or the third analysis result.

In some embodiments, the first analysis result has a first confidence, the second analysis result has a second confidence, the first analysis result has a third confidence, and the first confidence and the second confidence are both less than a confidence threshold;
and determining the first information based on the first analysis result, the second analysis result or the third analysis result comprises:
in response to determining that the third confidence is greater than or equal to the confidence threshold, determining the third analysis result as the first information;
in response to determining that the third confidence is less than the confidence threshold, determining an analysis result corresponding to a maximum value among the first confidence, the second confidence and the third confidence as the first information; or
in response to determining that the third confidence is less than the confidence threshold and the third confidence is equal to both the first confidence and the second confidence, determining the third analysis result as the first information.

When the third confidence is greater than or equal to a preset threshold, no more subsequent task will be performed, but the current third identification result is determined as the interface functional description information and/or the interface name information of the interface resource.

If the second confidence of the second analysis result is greater than or equal to the confidence threshold, then the second analysis result may be directly determined as the first information, without the need of performing further analysis on the query parameter or other subsequent task. If the second confidence of the second analysis result is less than the confidence threshold, then the query parameter may be further analyzed so as to improve the accuracy of semantic analysis of the API interface information. In FIG. 2, if the API interface information further comprises the query parameter, then semantic analysis may be performed in conjunction with the query parameter, the folded parameter, the interface path and the invocation approach, as shown by S230 in FIG. 2. Thereby, the role and functionality of the API interface is determined, and the third analysis result with more accurate interface functional description information is obtained. At this point, if the third confidence of the third analysis result is greater than or equal to the confidence threshold, then the third analysis result may be directly determined as the first information, without the need of performing subsequent semantic analysis on the query parameter. If the third confidence of the third analysis result is less than the confidence threshold, then all the confidences of the first analysis result, the second analysis result and the third analysis result are less than the confidence threshold, at which point the analysis result with a larger confidence may be determined as the first information. For example, when the first confidence is greater than the second confidence and the third confidence, the first analysis result corresponding to the first confidence is determined as the first information; when the second confidence is greater than the first confidence and the third confidence, the second analysis result corresponding to the second confidence is determined as the first information; when the third confidence is greater than the first confidence and the third confidence, the third analysis result corresponding to the third confidence is determined as the first information. If the first confidence, the second confidence and the third confidence are equal to each other, then the third analysis result may be determined as the first information.

In some embodiments, the method 100 may further comprise:
correcting the first information to obtain second information;
determining the API interface information and the second information as a positive training sample, and determining the API interface information and the first information as a negative training sample; and
determining the positive training sample and the negative training sample as second training data to train the target model, to update the target model.

In the process of training and applying the target model, further data processing may be performed to the generated first information, e.g., correcting the first information to obtain second information. When there appears interface functional description information and/or interface name information which does/do not meet requirements or is/are inaccurate, the interface functional description information and/or the interface name information which does/do not meet requirements may be determined as a negative sample, and the corrected second information may be determined as a positive sample. Then, the parameter and network of the target model is further adjusted and trained using the negative sample and the positive sample, so that the target model may be optimized and the accuracy of the target model may be continuously enhanced.

In some embodiments, the method 100 may further comprise:
detecting the first information based on a preset rule; and
in response to detecting that the first information comprises target information related to the preset rule, correcting the target information in the first information to update the first information.

Herein the preset rule may comprise markup descriptions which are allowed for the API interface or markup descriptions which are not allowed for the API interface. For example, to prevent misunderstanding of the interface name information, the first information may further be detected and corrected based on a preset rule (e.g., using a pretrained first model), and the process of identifying and generating the first information may be discriminated and corrected by the detection of the first model, so that the generated first information satisfies the preset rule.

At step S130, the API interface is marked based on the first information.

Marking the API interface may refer to adding a label to or categorizing the API interface based on a basic attribute and functional description (e.g., the first information) of the API interface, and may further refer to naming the API interface (i.e., writing the functionality and role of the API interface to its name information) to facilitate management and identification. For example, a corresponding mark or name may be assigned to the API interface based on the first information, thereby helping the user to fast locate and understand the functionality, usage scenario and limiting condition of the API interface. For example, if the API interface is used for user authentication, then a label “authentication”, “security” and the like may be marked for the API interface, or a functional description such as authentication may be added to the name of the API interface; if the API interface is used for data query, then the API interface may be marked as “query”, “read”, or a functional description such as query may be added to the name thereof. It is to be understood that the above marks and/or names are merely exemplary, and may comprise more description, which is not limited herein. By means of these marks or names, it is possible to effectively organize and retrieve API resources, thereby enhancing the development efficiency and the maintenance convenience. This helps to optimize the API interface performance, manage the resource use, guarantee security and understand the API use trend.

As described above, the method according to the embodiments of the present disclosure is capable of quickly and accurately extracting key descriptions and automatically marking functional information and name information of API interface resources through intelligent and semantic analysis of the API interface information, which can significantly improve the management efficiency and security of network security products such as Web application firewalls. Such a function not only simplifies the classification and identification of API interface resources but also enhances the detection and protection of API interface traffic, which enables network security products to respond more intelligently to increasingly complex threat environments and safeguard the safe and stable operation of Web applications.

It is to be noted that the method of the embodiments of the present disclosure may be performed by a single device, e.g., a computer or a server, etc. The method of the present embodiment may be applied in a distributed scenario and completed by a plurality of devices in cooperation with each other. In the case of such a distributed scenario, one of the plurality of devices may perform only one or more steps of the method of the embodiments of the present disclosure, and the plurality of devices will interact with each other to accomplish the described method.

It is to be noted that some of the embodiments of the present disclosure have been described above. Other embodiments fall within the scope of the claims as appended. In some cases, the acts or steps defined in the claims may be performed in a different order than the above embodiments and may still accomplish a desired result. In addition, the processes depicted in the accompanying drawings do not necessarily require the particular order or sequential order illustrated to achieve the desired results. In some implementations, multitasking and parallel processing are also possible or might be advantageous.

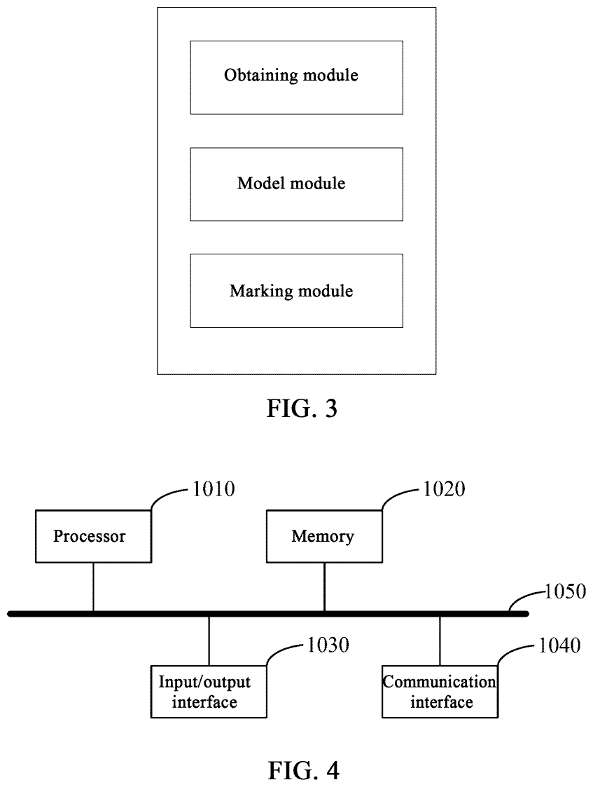

Based on the same inventive concept, the present disclosure further provides an apparatus for marking an API interface, corresponding to any of the above method embodiments. With reference to FIG. 3, the apparatus for marking an API interface comprises:
an obtaining module configured to obtain API interface information in API interface access traffic data;
a model module configured to input the API interface information into a target model to obtain first information about the API interface information output by the target model; wherein the first information comprises at least one of: functional description information and interface name information of the API interface, and wherein the target model is trained based on first training data, and the first training data comprises first interface information and corresponding first functional description information and/or first interface name information; and
a marking module configured to mark the API interface based on the first information.

Based on the same inventive concept and corresponding to any of the above method embodiments, the present disclosure further provides an electronic device, comprising a memory, a processor and a computer program stored on the memory and runnable on the processor, wherein the processor, when executing the program, implements a method of marking an API interface according to any of the above embodiments.

FIG. 4 shows a schematic diagram of a more specific hardware structure of an electronic device provided by this embodiment. The device may comprise: a processor 1010, a memory 1020, an input/output interface 1030, a communication interface 1040 and a bus 1050. Among them, the processor 1010, the memory 1020, the input/output interface 1030 and the communication interface 1040 are communicatively connected with each other via the bus 1050 within the device.

The processor 1010 may be implemented using a general-purpose CPU (Central Processing Unit), a microprocessor, an Application Specific Integrated Circuit (ASIC), or one or more integrated circuits for executing a relevant program to realize the technical solutions provided in the embodiments of this specification.

The memory 1020 may be implemented as ROM (Read Only Memory), RAM (Random Access Memory), a static storage device, a dynamic storage device and other form. The memory 1020 may store an operating system and other application programs, and in implementing the technical solutions provided in the embodiments of this specification by software or firmware, the relevant program code is stored in the memory 1020 and called by the processor 1010 for execution.

The input/output interface 1030 is used for connecting an input/output model to realize information input and output. The input/output module may be configured as a component in a device (not shown in the figures) and may also be external to the device to provide a corresponding function. The input apparatus may comprise a keyboard, mouse, touchscreen, microphone, various types of sensors, etc. The output apparatus may comprise a monitor, speaker, vibrator, indicator light, etc.

The communication interface 1040 is used for connecting a communication module (not shown in the figures) to enable communication interaction between the present device and other devices. The communication module may realize communication in a wired manner (e.g., USB, network cable, etc.) or in a wireless manner (e.g., mobile network, WIFI, Bluetooth, etc.).

The bus 1050 comprises a pathway via which information is transferred between various components of the device (such as the processor 1010, the memory 1020, the input/output interface 1030, and the communication interface 1040).

It is to be noted that although the above device shows only the processor 1010, the memory 1020, the input/output interface 1030, the communication interface 1040 and the bus 1050, in some implementations, the device may further comprise other components necessary to achieve normal operation. In addition, those skilled in the art may understand that the device may only comprise components necessary to implement the technical solutions of the embodiments in this specification, rather than comprising all components shown in the figures.

The electronic device according to the above embodiment is used for performing the corresponding method of marking an API according to any of the above embodiments, having the advantageous effects of the corresponding method embodiments, which is not described in details herein.

Based on the same inventive concept, corresponding to any of the above method embodiments, the present disclosure further provides a non-transitory computer readable storage medium, storing computer instructions which are used for causing the computer to perform a method of marking an API interface according to any of the above embodiments.

The computer readable medium according to the present embodiment comprises permanent and non-permanent, removable and non-removable media which may realize information storage by any method or technique. The information may be computer readable instructions, data structures, modules of a program, or other data. Examples of storage media for computers include, but are not limited to, phase-change memory (PRAM), static random-access memory (SRAM), dynamic random-access memory (DRAM), other types of random-access memory (RAM), read-only memory (ROM), electrically erasable programmable read-only memory (EEPROM), flash memory or other memory techniques, read-only compact disc read-only memory (CD-ROM), digital versatile disc (DVDs) or other optical storage, magnetic cartridge tapes, magnetic tape magnetic disk storage or other magnetic storage devices or any other non-transfer media which may be used to store information accessible by a computing device.

The computer instructions stored in the storage medium according to the above embodiment are used for causing the computer to perform the method of marking an API according to any of the above embodiments, having the advantageous effects of the corresponding method embodiment, which is not described in details herein.

Based on the same inventive concept, corresponding to the method of marking an API according to any of the above embodiments, the present disclosure further provides a computer program product, comprising computer program instructions. In some embodiments, the computer program instructions may be executed by one or more processors of a computer to enable the computer and/or the processor to perform the method of marking an API interface. Corresponding to the execution body corresponding to each step in each embodiment of marking an API interface as described, the processor performing the corresponding step may belong to the corresponding execution body.

The computer program product of the above embodiment is used for enabling the computer and/or the processor to perform the method of marking an API according to any of the above embodiments, having the advantageous effects of the corresponding method embodiments, which is not described in details herein.

It is known to those skilled in the art that the implementation of the present disclosure may be implemented as a system, method or computer program product. Therefore, the present disclosure may be specifically implemented in the form of complete hardware, complete software (including firmware, resident software, microcode, etc.), or a combination of hardware and software, which is generally referred to herein as a “circuit”, “module”, or “system”. Additionally, in some embodiments, the present disclosure may be further implemented in the form of a computer program product in one or more computer-readable media containing computer-readable program code.

Any combination of one or more computer readable media may be adopted. The computer readable medium may be a computer readable signal medium or a computer readable storage medium. The computer readable storage medium may be, for example, but not limited to, an electronic, magnetic, optical, electromagnetic, infrared, or semiconductor system, apparatus, or device, or any combination of the foregoing. More specific examples (non-exhaustive examples) of the computer readable storage medium may include, but are not limited to: an electrical connection having one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that may contain, or store, a program for use by or in connection with an instruction execution system, apparatus, or device.

A computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device.

Program code embodied on a computer readable medium may be transmitted using any appropriate medium, including but not limited to: electrical wires, optical cables, RF (radio frequency), etc., or any suitable combination of the foregoing.

Computer program codes for carrying out operations of the present disclosure may be written in one or more programming languages or a combination thereof, including without limitation to, an object oriented programming language such as Java, Smalltalk, C++ or the like, and conventional procedural programming languages, such as the “C” programming language or similar programming languages. The program codes may be executed entirely on the user's computer, partly on the user's computer, as a stand-alone software package, partly on the user's computer and partly on a remote computer or entirely on the remote computer or server. In the latter scenario, the remote computer may be connected to the user's computer through any type of network (including a local area network (LAN) or a wide area network (WAN)), or the connection may be made to an external computer (for example, through the Internet using an Internet Service Provider).

It is to be understood that each block in the flowcharts and/or block diagrams and a combination of respective blocks in the flowcharts and/or block diagrams may be implemented by computer program instructions. These computer program instructions may be provided to a processor of a general-purpose computer, a special-purpose computer or other programmable data processing apparatus, thereby producing a machine in which these computer program instructions are executed by the computer or other programmable data-processing apparatus, producing an apparatus that implements the functions/operations specified in the blocks in the flowcharts and/or block diagrams.

These computer program instructions may be also stored in a computer readable medium that enables the computer or other programmable data processing apparatus to work in a specific manner, such that the instructions stored in the computer readable medium produce a product comprising an instructional apparatus that implements the functions/operations described in the blocks in the flowcharts and/or block diagrams.

These computer program instructions may be also loaded to a computer, other programmable data processing apparatus or other device, causing a series of operation steps to be performed on the computer, other programmable data processing apparatus or other device to produce a process implemented by the computer, so that the instructions executed on the computer or other programmable apparatus can provide a process capable of performing the functions/operations described in the blocks in the flowcharts and/or block diagrams.

In addition, although various operations of the method disclosed herein are depicted in a particular order, this should not be construed as requiring or suggesting that these operations be performed in the particular order shown or that all the operations as shown be performed to achieve the desired results. On the contrary, the steps depicted in the flowcharts may change the execution order. Additionally or alternatively, some of the steps may be omitted, multiple steps may be combined into one step for execution, and/or one step may be decomposed into multiple steps for execution.

The flowcharts and block diagrams in the figures illustrate the architecture, functionality, and operation of possible implementations of systems, methods and computer program products according to various implementations of the present disclosure. In this regard, each block in the flowcharts or block diagrams may represent a module, segment, or portion of code, which comprises one or more executable instructions for implementing the specified logical function(s). It is also to be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It is also to be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be noted that although several modules or units of the apparatus for action execution have been described in detail above, this division is not mandatory. Indeed, according to implementations of the present application, the features and functions of two or more modules or units described above may be embodied in a single module or unit. Conversely, the features and functions of one module or unit described above may be further divided to be embodied by a plurality of modules or units.

Those of ordinary skill in the art should understand that the discussion of any of the above embodiments is merely exemplary and is not intended to imply that the scope of the present disclosure (including the claims) is limited to these examples; combinations between the above embodiments or technical features in different embodiments are also possible in the context of the present disclosure, and the steps may be realized in any order, and there exist many other variations of different aspects of the embodiments of the present disclosure as described above, which are not provided in the details for the sake of conciseness.

In addition, for simplicity of illustration and discussion, and in order not to make the embodiments of the present disclosure difficult to understand, well-known power/ground connections to integrated circuit (IC) chips and other components may or may not be shown in the accompanying drawings provided. In addition, the apparatus may be shown in the form of a block diagram, to avoid making the embodiments of the present disclosure difficult to understand, and this also takes into account the fact that the details regarding the implementations of these block diagram devices are highly dependent on the platform on which the embodiments of the present disclosure are to be implemented (i.e., these details should be well within the understanding of those skilled in the art). Where specific details (e.g., circuitry) are set forth to describe exemplary embodiments of the present disclosure, it will be apparent to those of skill in the art that the embodiments of the present disclosure may be implemented without these specific details or with alterations of these specific details. Accordingly, these descriptions should be considered illustrative and not limiting.

While the present disclosure has been described in conjunction with the specific embodiments of the present disclosure, according to the above description, many replacements, modifications and variations of these embodiments will be obvious to those of ordinary skill in the art. For example, other memory architecture (e.g., dynamic RAM (DRAM)) may use the discussed embodiments.

The embodiments of the present disclosure are intended to cover all such replacements, modifications and variations falling within the broad scope of the appended claims. Therefore, any omissions, modifications, equivalent replacements, improvements and the like made within the spirit and principles of the embodiments of the present disclosure should be included in the protection scope of the present disclosure.

I/We claim:

1. A method of marking an API interface, comprising:
obtaining API interface information in API interface access traffic data;
inputting the API interface information into a target model to obtain first information about the API interface information output by the target model, wherein the first information comprises at least one of: functional description information and interface name information of the API interface, and wherein the target model is trained based on first training data, and the first training data comprises first interface information and at least one of corresponding first functional description information or first interface name information; and
marking the API interface based on the first information.

2. The method of claim 1, wherein inputting the API interface information into the target model to obtain the first information about the API interface information output by the target model comprises:
performing, by the target model, semantic analysis on an interface path and an invocation approach in the API interface information to obtain a first analysis result; and
determining the first information based on the first analysis result.

3. The method of claim 2, wherein inputting the API interface information into the target model to obtain the first information about the API interface information output by the target model comprises:
aggregating and folding the API interface information to obtain a folded parameter of the API interface information;
in response to determining that the API interface information comprises the folded parameter, performing, by the target model, semantic analysis on the interface path, the invocation approach and the folded parameter to obtain a second analysis result; and
determining the first information based on at least one of the first analysis result or the second analysis result.

4. The method of claim 3, wherein the first analysis result has a first confidence, the second analysis result has a second confidence, and the first confidence is less than a confidence threshold,
and wherein determining the first information based on the first analysis result or the second analysis result comprises at least one of the following:
in response to determining that the second confidence is greater than or equal to the confidence threshold, determining the second analysis result as the first information;
in response to determining that the second confidence is less than the confidence threshold and the second confidence is greater than or equal to the first confidence, determining the second analysis result as the first information; or
in response to determining that the first confidence is greater than the second confidence, determining the first analysis result as the first information.

5. The method of claim 3, wherein inputting the API interface information into the target model to obtain the first information about the API interface information output by the target model comprises:
in response to determining that the API interface information further comprises a query parameter, performing, by the target model, semantic analysis on the interface path, the invocation approach, the folded parameter and the query parameter to obtain a third analysis result; and
determining the first information based on the first analysis result, the second analysis result or the third analysis result.

6. The method of claim 5, wherein the first analysis result has a first confidence, the second analysis result has a second confidence, the first analysis result has a third confidence, and the first confidence and the second confidence are both less than a confidence threshold,
and wherein determining the first information based on the first analysis result, the second analysis result or the third analysis result comprises at least one of the following:
in response to determining that the third confidence is greater than or equal to the confidence threshold, determining the third analysis result as the first information;
in response to determining that the third confidence is less than the confidence threshold, determining an analysis result corresponding to a maximum value among the first confidence, the second confidence and the third confidence as the first information; or
in response to determining that the third confidence is less than the confidence threshold and the third confidence is equal to both the first confidence and the second confidence, determining the third analysis result as the first information.

7. The method of claim 1, further comprising:
correcting the first information to obtain second information;
determining the API interface information and the second information as a positive training sample,
determining the API interface information and the first information as a negative training sample; and
determining the positive training sample and the negative training sample as second training data to train the target model, to update the target model.

8. The method of claim 1, further comprising:
detecting the first information based on a preset rule; and
in response to detecting that the first information comprises target information related to the preset rule, correcting the target information in the first information to update the first information.

9. An electronic device, comprising
a processor; and
a memory storing processor executable instructions,
wherein the instructions, when executed by the processor, cause the processors to:
obtain API interface information in API interface access traffic data;
input the API interface information into a target model to obtain first information about the API interface information output by the target model, wherein the first information comprises at least one of: functional description information and interface name information of the API interface, and wherein the target model is trained based on first training data, and the first training data comprises first interface information and at least one of corresponding first functional description information or first interface name information; and
mark the API interface based on the first information.

10. The electronic device of claim 9, wherein the instructions to input the API interface information into the target model to obtain the first information about the API interface information output by the target model comprise instructions to:
perform, by the target model, semantic analysis on an interface path and an invocation approach in the API interface information to obtain a first analysis result; and
determine the first information based on the first analysis result.

11. The electronic device of claim 10, wherein the instructions to input the API interface information into the target model to obtain the first information about the API interface information output by the target model comprise instructions to:
aggregate and folding the API interface information to obtain a folded parameter of the API interface information;
in response to determining that the API interface information comprises the folded parameter, perform, by the target model, semantic analysis on the interface path, the invocation approach and the folded parameter to obtain a second analysis result; and
determine the first information based on at least one of the first analysis result or the second analysis result.

12. The electronic device of claim 11, wherein the first analysis result has a first confidence, the second analysis result has a second confidence, and the first confidence is less than a confidence threshold,
and wherein the instructions to determine the first information based on the first analysis result or the second analysis result comprise at least one of instructions to:
in response to determining that the second confidence is greater than or equal to the confidence threshold, determine the second analysis result as the first information;
in response to determining that the second confidence is less than the confidence threshold and the second confidence is greater than or equal to the first confidence, determine the second analysis result as the first information; or
in response to determining that the first confidence is greater than the second confidence, determine the first analysis result as the first information.

13. The electronic device of claim 11, wherein the instructions to input the API interface information into the target model to obtain the first information about the API interface information output by the target model comprise instructions to:
in response to determining that the API interface information further comprises a query parameter, perform, by the target model, semantic analysis on the interface path, the invocation approach, the folded parameter and the query parameter to obtain a third analysis result; and
determine the first information based on the first analysis result, the second analysis result or the third analysis result.

14. The electronic device of claim 13, wherein the first analysis result has a first confidence, the second analysis result has a second confidence, the first analysis result has a third confidence, and the first confidence and the second confidence are both less than a confidence threshold,
and wherein the instructions to determine the first information based on the first analysis result, the second analysis result or the third analysis result comprises at least one of instructions to:
in response to determining that the third confidence is greater than or equal to the confidence threshold, determine the third analysis result as the first information;
in response to determining that the third confidence is less than the confidence threshold, determine an analysis result corresponding to a maximum value among the first confidence, the second confidence and the third confidence as the first information; or
in response to determining that the third confidence is less than the confidence threshold and the third confidence is equal to both the first confidence and the second confidence, determine the third analysis result as the first information.

15. The electronic device of claim 9, wherein the instructions further comprises instructions to:
correct the first information to obtain second information;
determine the API interface information and the second information as a positive training sample,
determine the API interface information and the first information as a negative training sample; and
determine the positive training sample and the negative training sample as second training data to train the target model, to update the target model.

16. The electronic device of claim 9, wherein the instructions further comprises instructions to:
detect the first information based on a preset rule; and
in response to detecting that the first information comprises target information related to the preset rule, correct the target information in the first information to update the first information.

17. A computer program product being stored on a non-transitory computer readable storage medium and comprising computer executable instructions, wherein the instructions, when executed by a processor, cause the processor to:
obtain API interface information in API interface access traffic data;
input the API interface information into a target model to obtain first information about the API interface information output by the target model, wherein the first information comprises at least one of: functional description information and interface name information of the API interface, and wherein the target model is trained based on first training data, and the first training data comprises first interface information and at least one of corresponding first functional description information or first interface name information; and
mark the API interface based on the first information.

18. The computer program product of claim 17, wherein the instructions to input the API interface information into the target model to obtain the first information about the API interface information output by the target model comprise instructions to:
perform, by the target model, semantic analysis on an interface path and an invocation approach in the API interface information to obtain a first analysis result; and
determine the first information based on the first analysis result.

19. The computer program product of claim 18, wherein the instructions to input the API interface information into the target model to obtain the first information about the API interface information output by the target model comprise instructions to:
aggregate and folding the API interface information to obtain a folded parameter of the API interface information;
in response to determining that the API interface information comprises the folded parameter, perform, by the target model, semantic analysis on the interface path, the invocation approach and the folded parameter to obtain a second analysis result; and
determine the first information based on at least one of the first analysis result or the second analysis result.

20. The computer program product of claim 19, wherein the first analysis result has a first confidence, the second analysis result has a second confidence, and the first confidence is less than a confidence threshold,
and wherein the instructions to determine the first information based on the first analysis result or the second analysis result comprise at least one of instructions to:
in response to determining that the second confidence is greater than or equal to the confidence threshold, determine the second analysis result as the first information;
in response to determining that the second confidence is less than the confidence threshold and the second confidence is greater than or equal to the first confidence, determine the second analysis result as the first information; or
in response to determining that the first confidence is greater than the second confidence, determine the first analysis result as the first information.
